(19) United States
(12) Patent Application Publication
(10) Pub. No.: US 2026/0005446 A1
(43) Pub. Date: Jan. 1, 2026

(54) ARRAY ANTENNA AND ELECTROMAGNETIC WAVE DEVICE

(71) Applicant: TAIYO YUDEN CO., LTD., Tokyo (JP)

(72) Inventor: Hiroyuki KAMO, Tokyo (JP)

(73) Assignee: TAIYO YUDEN CO., LTD., Tokyo (JP)

(21) Appl. No.: 19/321,883

(22) Filed: Sep. 8, 2025

Related U.S. Application Data
(63) Continuation of application No. PCT/JP2023/047200, filed on Dec. 28, 2023.

(30) Foreign Application Priority Data
Mar. 30, 2023 (JP) 2023-055530

(51) Int. Cl. H01Q 21/00; H01Q 21/06

(52) U.S. Cl. CPC H01Q 21/0037; H01Q 21/061

(57) ABSTRACT

An array antenna includes a first member having first through holes arranged along a first direction, a second member that is provided to overlap with the first member, and has second through holes and third through holes, first waveguide members each having a ridge shape, each of the first waveguide members being in contact with one of a first surface of the first member and a second surface of the second member, a first air gap functioning as a waveguide being formed between each of the first waveguide members and another of the first and the second surfaces, and a plurality of rods provided around the first waveguide members, the rods being in contact with one of the first and the second surfaces, a second air gap being formed between the rods and the another of the first and the second surfaces.

### CROSS-REFERENCE TO RELATED APPLICATION

This application is based upon and claims the benefit of priority of the prior International Patent Application No. PCT/JP2023/047200, filed on Dec. 28, 2023, which claims the benefits of priorities of Japanese Patent Application No. 2023-055530 filed on Mar. 30, 2023, the entire contents of which are incorporated herein by reference.

### FIELD

A certain aspect of the present disclosure relates to an array antenna and an electromagnetic wave device.

### BACKGROUND

An array antenna having an array structure in which a plurality of antenna elements (emitting elements) are arranged on a line or a plane is used for various applications such as a radar or a communication system. In order to emit electromagnetic waves from the array antenna, electromagnetic waves, for example, high-frequency electromagnetic waves obtained by modulating signal waves are supplied from a transmitting circuit that generates electromagnetic waves to antenna elements. The supply of such electromagnetic waves is performed via a waveguide. The waveguide is also used to transmit the electromagnetic waves received by the antenna elements to a receiving circuit.

It is known to use a microstrip line for feeding power to the antenna element. However, when the frequency of the electromagnetic wave transmitted or received by the antenna element is a frequency equal to or higher than 30 GHz, such as a millimeter-wave band, the dielectric loss of the microstrip line increases. The loss can be reduced by feeding power to the antenna element using a waveguide tube instead of the microstrip line. However, in the case of using the waveguide tube, a hollow portion of the waveguide tube needs to have a width equal to or larger than a half wavelength of the electromagnetic wave. In the array antenna, for example, when it is desired to eliminate a folded virtual image of a detection target, it is necessary to set the arrangement period of the antenna elements to the half wavelength of the electromagnetic wave. This cannot be constructed with the waveguide tube because the hollow portion of the waveguide tube must have a width equal to or greater than the half wavelength of the electromagnetic wave. Therefore, a waffle-iron ridge guide is used, which has a small waveguide loss even in the millimeter wave band and in which antenna elements can be arranged at a narrow interval of a half wavelength or about the half wavelength. That is, an array antenna having a waveguide structure that guides electromagnetic waves by using artificial magnetic conductors (AMCs) disposed on both sides of a ridge waveguide has been proposed (for example, Japanese Laid-Open Patent Publication No. 2021-118446, Japanese National Publication of International Patent Application No. 2020-517175 and Japanese Laid-Open Patent Publication No. 2018-207487). By using the ridge waveguide, the width of the waveguide can be narrowed.

### SUMMARY OF THE INVENTION

According to a first aspect of the present disclosure, there is provided an array antenna including: a first member having a plurality of first through holes arranged along a first direction, the first member having conductive surfaces, a direction orthogonal to the first direction being defined as a second direction, and a direction orthogonal to both the first direction and the second direction being defined as a third direction; a second member that is provided to overlap with the first member in plan view in the third direction, and has a plurality of second through holes provided on one side with respect to the plurality of first through holes in the second direction and a plurality of third through holes provided on another side with respect to the plurality of first through holes in the second direction, the second member having conductive surfaces; a plurality of first waveguide members each having a ridge shape and conductive surfaces, each of the first waveguide members being in contact with one of a first surface of the first member facing the second member and a second surface of the second member facing the first member, a first air gap functioning as a waveguide being formed between each of the first waveguide members and another of the first surface and the second surface, one end of each of the first waveguide members receiving a power from each of the plurality of second through holes or each of the plurality of third through holes, and another end of each of the first waveguide members feeding the power to each of the plurality of first through holes, or one end of each of the first waveguide members receiving a power from each of the plurality of first through holes, and another end of each of the first waveguide members feeding the power to each of the plurality of second through holes or each of the plurality of third through holes; and a plurality of rods having conductive surfaces, the rods being provided around the plurality of first waveguide members, the rods being in contact with one of the first surface and the second surface and extending toward another of the first surface and the second surface, a second air gap being formed between the rods and the another of the first surface and the second surface.

According to a second aspect of the present disclosure, there is provided an electromagnetic wave device including: the array antenna according to the above first aspect of the present disclosure; and an integrated circuit connected to the array antenna.

### BRIEF DESCRIPTION OF THE DRAWINGS

FIG. 1A is a plan view of a first member of an array antenna according to a first embodiment, and FIG. 1B is a plan view of a second member of the array antenna according to the first embodiment.

FIG. 2A and FIG. 2B are cross-sectional views of the array antenna according to the first embodiment.

FIG. 3 is a plan view illustrating first through holes of the first member in a state of being overlapped with the second member in the first embodiment.

FIG. 4 is a plan view illustrating first through holes of the first member in a state of being overlapped with the second member in a modification of the first embodiment;

FIG. 5 is a plan view illustrating first through holes of the first member in a state of being overlapped with the second member in a first comparative example.

FIG. 6A is a cross-sectional view illustrating another example of rods, and FIG. 6B is a cross-sectional view illustrating another example of a first waveguide member.

FIG. 7A to FIG. 7D are plan views illustrating other examples of first to third through holes.

FIG. 8 is a plan view illustrating first through holes of the first member in a state of being overlapped with the second member in a second embodiment.

FIG. 9 is a plan view illustrating first through holes of the first member in a state of being overlapped with the second member in a modification of the second embodiment.

FIG. 10 is a plan view illustrating first through holes of the first member in a state of being overlapped with the second member in a second comparative example.

FIG. 11 is a plan view illustrating first through holes of the first member in a state of being overlapped with the second member in a third comparative example.

FIG. 12 is an exploded perspective view of an electromagnetic wave device according to a third embodiment.

FIG. 13 is a plan view of a first member in the third embodiment.

FIG. 14 is a plan view of a second member in the third embodiment.

FIGS. 15A and 15B are cross-sectional views of an array antenna in the third embodiment.

FIG. 16 is a plan view illustrating first through holes and fourth through holes of the first member in a state of being overlapped with the second member in the third embodiment.

FIG. 17 is a plan view illustrating integrated circuits in a state of being overlapped with the second member in the third embodiment.

FIGS. 18A and 18B are plan views (Part 1) illustrating other arrangement examples of the first through holes and the fourth through holes.

FIGS. 19A and 19B are plan views (Part 2) illustrating other arrangement examples of the first through holes and the fourth through holes.

FIG. 20 is a schematic diagram of a monitoring system according to a fourth embodiment.

FIG. 21 is a block diagram of the monitoring system according to the fourth embodiment.

FIG. 22 is a flowchart illustrating an example of processing performed by a processing circuit according to the fourth embodiment.

FIG. 23 is a plan view illustrating an arrangement of the plurality of first through holes.

### DETAILED DESCRIPTION

In a ridge waveguide structure in which a ridge-shaped waveguide member is provided between a first member and a second member, through holes through which power is fed to the waveguide member or through which power is fed from the waveguide member may be arranged on the first member along one direction. In the ridge waveguide structure, the air gap on the waveguide member serves as a waveguide, and therefore the air gaps on the plurality of waveguide members connected to the plurality of through holes arranged along one direction are connected to each other. This may reduce the isolation between the waveguides of the plurality of waveguide members.

The present disclosure has been made in view of the above problem, and an object of the present disclosure is to suppress a decrease in isolation.

Hereinafter, embodiments of the present invention will be described with reference to the drawings.

### First Embodiment

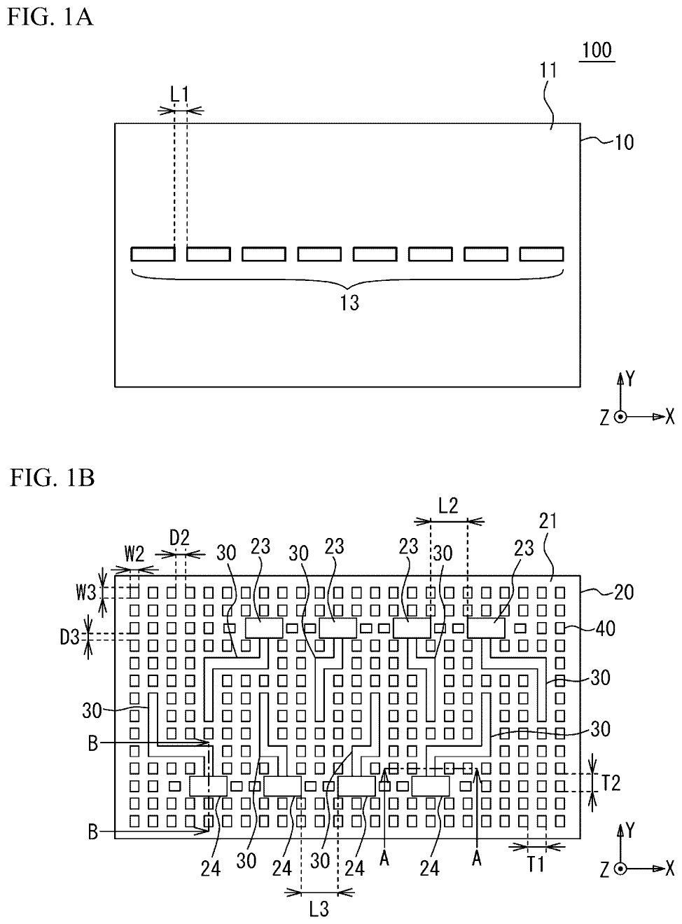

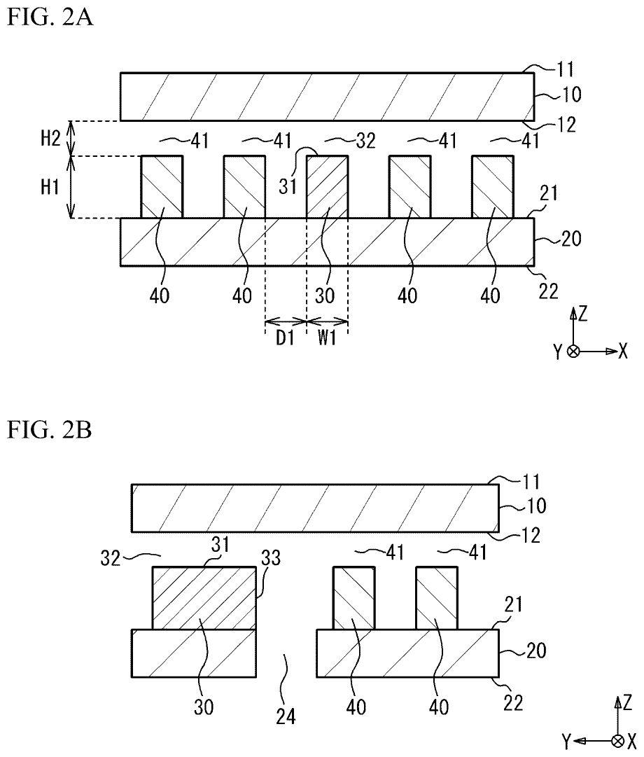

FIG. 1A is a plan view of a first member of an array antenna according to a first embodiment, and FIG. 1B is a plan view of a second member of the array antenna according to the first embodiment. FIGS. 2A and 2B are cross-sectional views of the array antenna according to the first embodiment. FIG. 2A is a cross-sectional view taken along a line A-A in FIG. 1B, and FIG. 2B is a cross-sectional view taken along a line B-B in FIG. 1B. Directions orthogonal to each other on the front surface 21 of the second member 20 are defined as an X-axis direction and a Y-axis direction, and a direction perpendicular to the front surface 21 is defined as a Z-axis direction. In the present specification, the expression “plan view in the Z-axis direction” with respect to an object means an arrangement relationship in a plan view shape when the object is viewed from a +Z direction to a −Z direction.

As illustrated in FIGS. 1A, 1B, 2A and 2B, an array antenna 100 according to the first embodiment includes a first member 10 and a second member 20. The first member 10 has a front surface 11 having conductivity and a back surface 12 having conductivity on the opposite side of the front surface 11. The second member 20 faces the back surface 12 of the first member 10, overlaps with the first member 10 in the plan view in the Z-axis direction, and has a conductive front surface 21 facing the back surface 12 and a back surface 22 having conductivity on the opposite side of the front surface 21. The back surface 12 of the first member 10 and the front surface 21 of the second member 20 extend two dimensionally along the XY plane. The first member 10 and the second member 20 may be conductive members formed by processing such as molding or cutting a conductive metal, or may be provided with a conductive film such as a metal film formed by plating, coating, surface treatment, or the like on the surface of an insulating member such as a resin. The first member 10 and the second member 20 are, for example, plate-shaped members.

The first member 10 has a plurality of first through holes 13 arranged at equal intervals in the X-axis direction. The first through hole 13 penetrates from the front surface 11 of the first member 10 to the back surface 12. The plurality of first through holes 13 have rectangular shapes of the same size in plan view in the Z-axis direction. A longitudinal direction of each of the plurality of first through holes 13 is the X-axis direction.

A plurality of first waveguide members 30 each having a ridge shape are provided on the front surface 21 of the second member 20. The plurality of first waveguide members 30 extend in the plane direction of the front surface 21 of the second member 20. Each of the plurality of first waveguide members 30 has a conductive surface. The plurality of first waveguide members 30 may be conductive members formed by processing, such as molding or cutting, a conductive metal, or may be provided with a conductive film, such as a metal film, formed by plating, coating, surface treatment, or the like on the surface of an insulating member such as a resin. Further, a plurality of rods 40 are provided on the front surface 21 of the second member 20, and the rods 40 are arranged on both sides of each of the plurality of first waveguide members 30. The rod 40 has a conductive surface. The rod 40 may be a conductive member formed by processing a conductive metal such as molding or cutting, or may be provided with a conductive film such as a metal film formed by plating, coating, surface treatment, or the like on the surface of an insulating member such as a resin. The first waveguide members 30 and the rods 40 may be formed integrally with the second member 20 as part of the second member 20, or may be members separate from the second member 20.

The end of the first waveguide member 30 in the −Z direction is in contact with the conductive front surface 21 of the second member 20. In the present specification, the term “contact” means that a state in which a part or all of the respective conductive surfaces are fixed to each other while ensuring an electrical conduction state. The term “contact” includes not only a case where two objects are physically in contact with each other, but also a case where the two objects are integrally formed, and a case where the two objects are in contact with each other via a conductive material (including a conductive solid material such as metal, a conductive adhesive, a conductive oil, and the like). The end of the first waveguide member 30 in the +Z direction is not in contact with the first member 10, and is provided away from the conductive back surface 12 of the first member 10. The surface of the first waveguide member 30 that faces the back surface 12 of the first member 10 (the end face on the +Z direction side) is a conductive first waveguide surface 31. The first waveguide surface 31 extends along the direction in which the first waveguide member 30 extends. A first air gap 32 is formed between the back surface 12 of the first member 10 and the first waveguide surface 31 of the first waveguide member 30. A waveguide of the electromagnetic wave is formed in the first air gap 32. That is, the electromagnetic wave propagates through the first air gap 32.

The rod 40 has, for example, a rectangular parallelepiped shape and extends from the front surface 21 of the second member 20 toward the first member 10. The end of the rod 40 in the −Z direction is in contact with the front surface 21 of the second member 20. The end (tip) of the rod 40 in the +Z direction is not in contact with the first member 10, and a second air gap 41 is formed between the first member 10 and the end of the rod 40 in the +Z direction. The plurality of rods 40 arranged around the first waveguide member 30 form an artificial magnetic conductor, which is a structure that artificially realizes the properties of a perfect magnetic conductor. The artificial magnetic conductor is a structure that artificially realizes the properties of the perfect magnetic conductor (PMC) that does not exist in nature. The perfect magnetic conductor has a property that the tangential component of the magnetic field at the surface is zero. The artificial magnetic conductor functions as the perfect magnetic conductor in a specific frequency band determined by its structure, and suppresses propagation of electromagnetic waves having frequencies included in the specific frequency band along the surface of the artificial magnetic conductor. In this way, by arranging the plurality of rods 40 around the first waveguide member 30, the plurality of rods 40 function as magnetic walls, and the electromagnetic waves propagating through the first air gap 32 on the first waveguide member 30 are suppressed from leaking laterally. A waffle-iron ridge guide (WRG) formed by ridge-shaped first waveguide member 30 provided between the rods 40 functioning as artificial magnetic conductors can realize an array antenna with low loss in the microwave or millimeter-wave band.

The rod 40 may have a shape other than the rectangular parallelepiped shape, such as a cylindrical shape or an elliptic cylindrical shape. At least a part of the side surface of the rod 40 may be tapered. Further, the rod 40 may have a structure in which the corner portion of the tip surface or the corner portion of the side surface of the rod 40 is rounded or chamfered.

The first waveguide member 30 has a width W1 (see FIG. 2A) of, for example, about λ₀/8, which is smaller than λ₀/4 and larger than λ₀/16, where λ₀ is a typical value (e.g., a center wavelength corresponding to a center frequency of operating frequency band) of wavelengths of propagating electromagnetic waves in free space. Widths W2 and W3 of the rod 40 (see FIG. 1B) are also, for example, about λ₀/8, and are, for example, smaller than λ₀/4 and larger than λ₀/16. The widths W1, W2, and W3 may be the same as or different from each other.

An arrangement period T1 and an arrangement period T2 (see FIG. 1B) of the plurality of rods 40 are smaller than λ₀/2, and are suitably within a range of λ₀/4±λ₀/8, for example. The arrangement period T1 and the arrangement period T2 may be the same as or different from each other. A distance D1 between the first waveguide member 30 and the rod 40 (see FIG. 2A) is, for example, about λ₀/8, which is smaller than λ₀/4 and larger than λ₀/16, for example. A distance D2 and a distance D3 (see FIG. 1B) between the plurality of rods 40 are also, for example, about λ₀/8, and are, for example, smaller than λ₀/4 and larger than λ₀/16. The distance D1, the distance D2, and the distance D3 may be the same as or different from each other.

A height H1 of the first waveguide member 30 and the rods 40 (see FIG. 2A) is, for example, greater than the widths W1, W2, and W3 and less than λ₀/2, and is suitably within a range of, for example, λ₀/4±λ₀/8. The height of the first waveguide member 30 and the height of the rods 40 may be the same as or different from each other. The height of the first air gap 32 and the height H2 of the second air gap 41 (see FIG. 2A) are, for example, less than λ₀/2. The height of the first air gap 32 and the height of the second air gap 41 may be the same as or different from each other. Here, the reason why the free space wavelength λ₀ is used is that the wavelength of the propagating electromagnetic wave is difficult to grasp because it can be variously changed by being affected by the dimensions, forms, and the like of the respective constituent members. The frequency band used in the array antenna 100 is, for example, a millimeter wave band from 30 GHz to 300 GHz.

The second member 20 is provided with a plurality of second through holes 23 and a plurality of third through holes 24 adjacent to tips 33 of the plurality of first waveguide members 30. The second through holes 23 and the third through holes 24 penetrate between the front surface 21 and the back surface 22 of the second member 20. Each of the second through holes 23 and the third through holes 24 have a rectangular shape in plan view in the Z-axis direction. The plurality of second through holes 23 and the plurality of third through holes 24 have the same sizes in plan view in the Z-axis direction, for example.

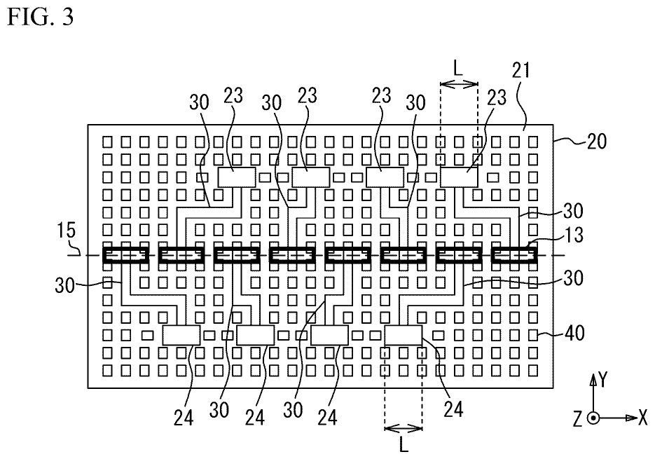

FIG. 3 is a plan view illustrating the first through holes of the first member in a state of being overlapped with the second member in the first embodiment. In FIG. 3, the outline of the first through hole 13 is illustrated by a thick line for the sake of clarity of the drawing (the same applies to the following similar drawings). As illustrated in FIG. 3, the plurality of second through holes 23 are located in the +Y direction with respect to an imaginary line 15 on which the plurality of first through holes 13 are arranged, and are arranged in the X-axis direction. The plurality of third through holes 24 are located in the −Y direction with respect to the imaginary line 15 on which the plurality of first through holes 13 are arranged, and are arranged in the X-axis direction. The plurality of second through holes 23 and the plurality of third through holes 24 have conductive inner side surfaces. Therefore, the plurality of second through holes 23 and the plurality of third through holes 24 function as waveguide tubes through which electromagnetic waves propagate. In plan view in the Z-axis direction, one end of each of the plurality of first waveguide members 30 overlaps with the first through hole 13, and the other end of each of the plurality of first waveguide members 30 is adjacent to the second through hole 23 or the third through hole 24. Thus, the waveguide formed by the first air gap 32 on the first waveguide member 30 receives a power from the second through hole 23 and the third through hole 24 and feeds the power to the first through hole 13, or receives a power from the first through hole 13 and feeds the power to the second through hole 23 and the third through hole 24.

The plurality of rods 40 are arranged around the second through holes 23 and the third through holes 24. By providing the rods 40 in the vicinity of the corner portions of the second through holes 23 and the third through holes 24, the electromagnetic waves are suppressed from leaking to the lateral sides of the second through holes 23 and the third through holes 24. Since the second through holes 23 and the third through holes 24 function as the waveguide tubes, the length L of the second through holes 23 and the third through holes 24 in the X-axis direction is equal to or longer than a half wavelength of the propagating electromagnetic wave. The reason why the first waveguide members 30 are adjacent to the second through holes 23 and the third through holes 24 in the direction (the Y-axis direction) orthogonal to the longitudinal direction (the X-axis direction) of the second through holes 23 and the third through holes 24 is to cause the electric field direction of the electromagnetic field to coincide with the X-axis direction in the first waveguide members 30 and the second through hole 23 and the third through holes 24.

The plurality of first through holes 13 are provided so as to overlap with the ends of the plurality of first waveguide members 30. In a case where a horn antenna is connected to the upper portion of the first through hole 13, the first waveguide member 30 extends in a direction (Y-axis direction) orthogonal to the longitudinal direction (X-axis direction) of the first through hole 13 so as to overlap the first through hole 13, for the horn antenna, for matching and directivity of a transmission line, or for ensuring a frequency band. For example, an electromagnetic wave propagating through the first air gap 32 on the first waveguide member 30 is emitted to or incident from the external space via the first through hole 13, and is supplied from or extracted to the lower side of the second member 20 via the second through hole 23 and the third through hole 24. In this case, the first through hole 13 functions as an antenna element (emitting element) that transmits or receives electromagnetic waves to or from the external space. The electromagnetic wave propagating through the first air gap 32 on the first waveguide member 30 may be emitted to or incident from the external space via the second through hole 23 and the third through hole 24, and may be supplied from or extracted to the upper side of the first member 10 via the first through hole 13. In this case, the second through hole 23 and the third through hole 24 function as antenna elements. In the first embodiment, the first through hole 13 is described as the antenna element.

The plurality of first through holes 13, which are antenna elements, are arranged at a high density in the X-axis direction for wide-angle scanning of electromagnetic waves. For example, an interval L1 (see FIG. 1A) between adjacent first through holes 13 is equal to or less than ¼ of the wavelength of the electromagnetic wave. In order to align the polarization directions of the electromagnetic waves, the longitudinal directions of the plurality of first through holes 13 are the same direction (X-axis direction). When the electromagnetic wave propagating through the first air gap 32 of the first waveguide member 30 is supplied or extracted via the second through hole 23 and the third through hole 24, power feeding units are provided so as to overlap with the second through hole 23 and the third through hole 24. For the structural reason of the power feeding units, the interval L2 (see FIG. 1B) between the adjacent second through holes 23 and the interval L3 (see FIG. 1B) between the adjacent third through holes 24 are wider than the interval L1 (see FIG. 1A) between the adjacent first through holes 13.

The plurality of first waveguide members 30 extend alternately from the plurality of first through holes 13 arranged in the X-axis direction to the opposite sides in the Y-axis direction (+Y direction and −Y direction) with respect to the imaginary line 15 along which the plurality of first through holes 13 are arranged. That is, the first waveguide member 30 located farthest in the −X direction extends from the first through hole 13 in the −Y direction, the first waveguide member 30 adjacent thereto extends from the first through hole 13 in the +Y direction, and the first waveguide member 30 further adjacent thereto extends from the first through hole 13 in the −Y direction. For example, the plurality of first waveguide members 30 extend from the first through hole 13 in the Y-axis direction, bend, and then extend again in the Y-axis direction to be adjacent to the second through hole 23 or the third through hole 24.

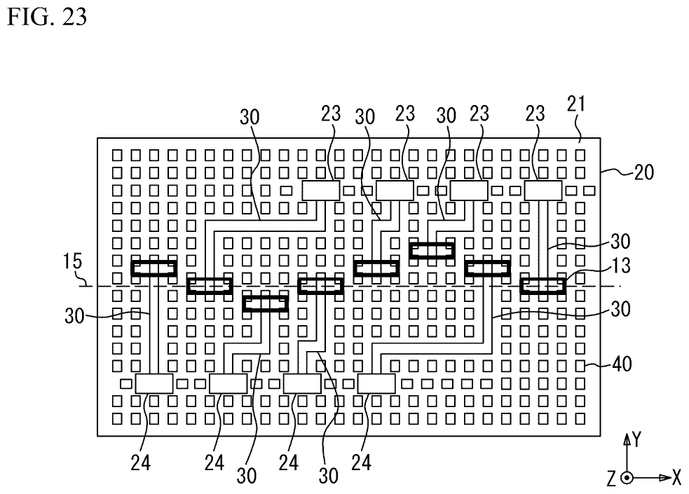

The plurality of first through holes 13 may be arranged along the X axis, although they are deviated from the X axis. The arrangement of the first through holes 13 along the X axis includes a case where the arrangement of the first through holes 13 is deviated from the X axis due to a processing error or the like at the time of mass production, and a case where the arrangement of the first through holes 13 is intentionally inclined from the X axis by several degrees. Furthermore, as illustrated in FIG. 23, the case where the plurality of first through holes 13 are arranged in the X-axis direction and in a zigzag manner in the Y-axis direction is also included in the case where the plurality of first through holes 13 are arranged along the X-axis. This is because the intended function on the waveguide is realized by these arrangements, and the structure of the present disclosure is used. The plurality of first waveguide members 30 may partially extend continuously from the first through hole 13 toward the same side in the Y-axis direction with respect to the first through hole 13.

### Modification

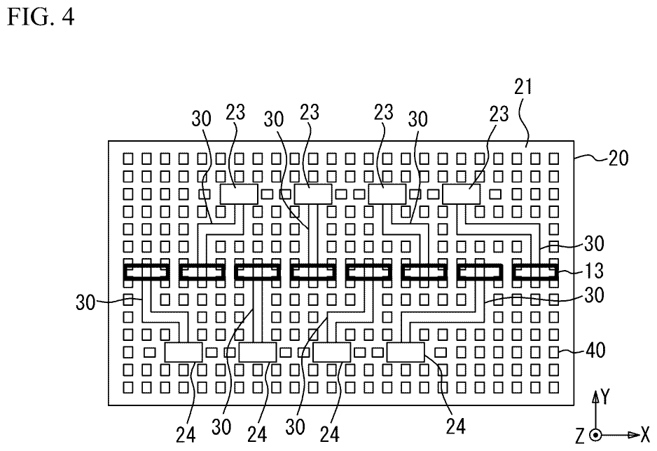

FIG. 4 is a plan view illustrating first through holes of the first member in a state of being overlapped with the second member in a modification of the first embodiment. As illustrated in FIG. 4, in the modification of the first embodiment, two first waveguide members 30 of the plurality of first waveguide members 30 are provided so as to extend in a straight line between the first through hole 13 and the second through hole 23 or the third through hole 24. The other configurations are the same as those of the first embodiment, and thus the description thereof will be omitted.

### Comparative Example

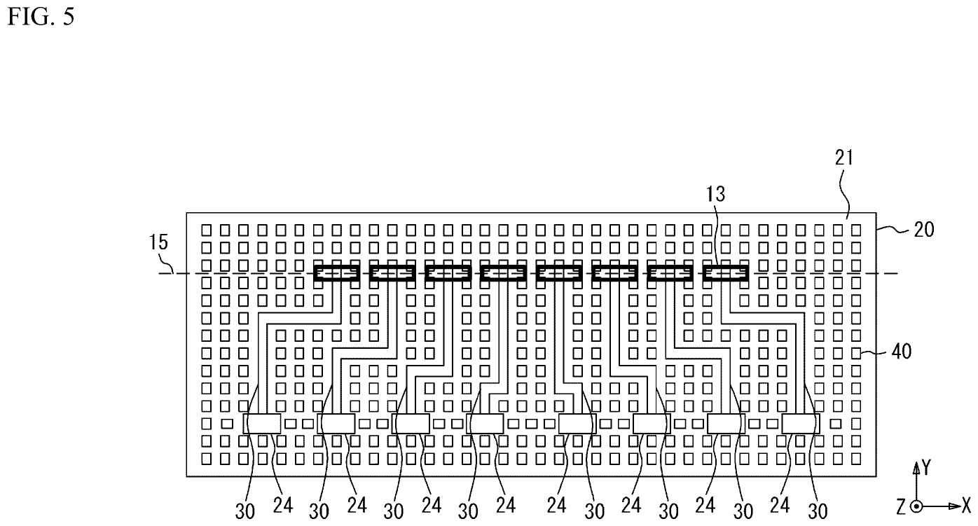

FIG. 5 is a plan view illustrating first through holes of the first member in a state of being overlapped with the second member in a first comparative example. As illustrated in FIG. 5, in the first comparative example, the plurality of third through holes 24 are provided to be located on the −Y direction side with respect to the imaginary line 15 along which the plurality of first through holes 13 are arranged, but the second through holes located on the +Y direction side with respect to the imaginary line 15 along which the plurality of first through holes 13 are arranged are not provided. The other configurations are the same as those of the first embodiment, and thus the description thereof will be omitted.

Also in the first comparative example, the longitudinal direction of the first through holes 13 is the X-axis direction so that the polarization directions of the electromagnetic waves are aligned, the plurality of first through holes 13 are arranged at a high density in the X-axis direction for wide-angle scanning of the electromagnetic waves. In such a case, if only the plurality of third through holes 24 located on the −Y direction side of the imaginary line 15 along which the plurality of first through holes 13 are arranged are provided, the plurality of first waveguide members 30 are arranged close to each other. The artificial magnetic conductor formed by the rods 40 provided around the first waveguide member 30 suppresses the propagation of electromagnetic waves having frequencies included in a specific frequency band, but the effect of suppressing the propagation of electromagnetic waves outside this frequency band is reduced. Since the first air gaps 32 that serve as waveguides on the first waveguide members 30 are connected to each other between the plurality of first waveguide members 30, the isolation between the waveguides of adjacent first waveguide members 30 may be reduced.

As described above, the interval between the adjacent third through holes 24 is increased due to the structural reason of the power feeding unit provided to overlap with the third through hole 24. Therefore, the size in the X-axis direction of a region where the plurality of third through holes 24 are provided may be larger than the size in the X-axis direction of a region where the plurality of first through holes 13 are provided. In this case, the size of the array antenna is increased in the X-axis direction.

On the other hand, in the first embodiment and the modification thereof, as illustrated in FIGS. 3, 4, and 23, the plurality of second through holes 23 are provided on the +Y direction side (one side) with respect to the plurality of first through holes 13 arranged along the X-axis direction, and the plurality of third through holes 24 are provided on the −Y direction side (the other side). Thus, at least some of the plurality of first waveguide members 30 connecting the first through hole 13 and the second through hole 23 or the third through hole 24 are provided so as to extend on the opposite side in the Y-axis direction with respect to the first waveguide member 30 extending from the adjacent first through hole 13. This makes it possible to suppress a decrease in isolation between the waveguides in the first waveguide member 30 and another first waveguide member 30 extending from the adjacent first through hole 13 to the opposite side in the Y-axis direction.

In the first embodiment, as illustrated in FIG. 3, the plurality of first waveguide members 30 extend from the plurality of first through holes 13 alternately to the opposite side in the +Y direction and the −Y direction with respect to the first through holes 13, and are adjacent to the second through holes 23 or the third through holes 24. This makes it possible to suppress a decrease in isolation between waveguides in all of the plurality of first waveguide members 30.

In the first embodiment and the modification thereof, as illustrated in FIGS. 1A and 1B, the interval L2 between the second through holes 23 and the interval L3 between the third through holes 24 are wider than the interval L1 between the first through holes 13. In such a case, as illustrated in FIG. 5 of the first comparative example, when the second through hole 23 is not provided and only the third through hole 24 is provided, the array antenna is increased in size in the X-axis direction, but in the first embodiment, the second through hole 23 and the third through hole 24 are provided on the opposite sides in the +Y direction and the −Y direction with respect to the first through hole 13, respectively, and thus the array antenna can be reduced in size in the X-axis direction.

In the first embodiment and the modification thereof, at least one of the plurality of first waveguide members 30 extends while bending between the first through hole 13 and the second through hole 23 or the third through hole 24. This makes it easy to adjust the interval between the plurality of first through holes 13, the interval between the plurality of second through holes 23, and the interval between the plurality of third through holes 24 to any size.

In the modification of the first embodiment, at least one of the plurality of first waveguide members 30 extends in a straight line between the first through hole 13 and the second through hole 23 or the third through hole 24. This makes it easier to obtain a structure in which the leakage of the propagating electromagnetic waves is suppressed in the first waveguide member 30 provided in a straight line.

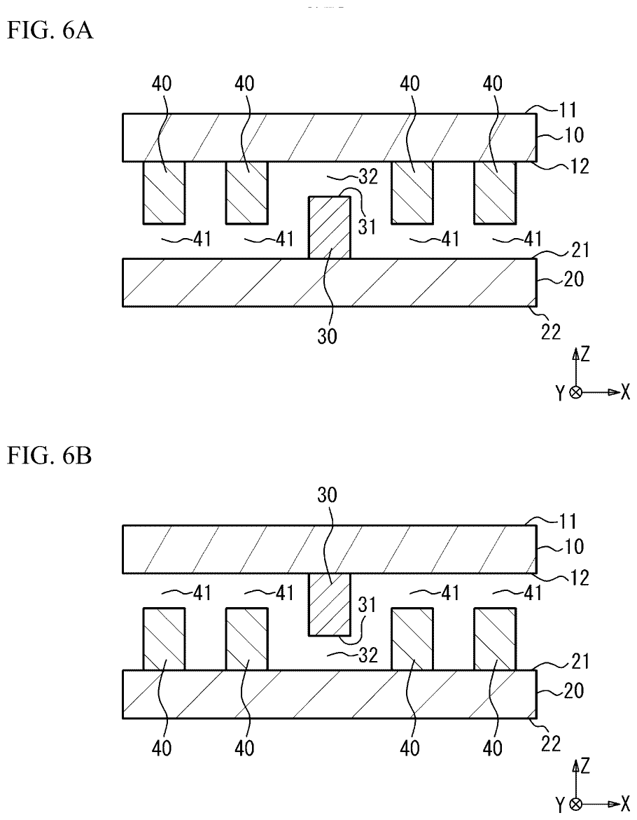

In the first embodiment and the modification thereof, the case where the rods 40 extend from the front surface 21 of the second member 20 toward the first member 10 and the second air gaps 41 are formed between the rods 40 and the back surface 12 of the first member 10 is described as an example, but the present disclosure is not limited to this case. FIG. 6A is a cross-sectional view illustrating another example of the rods. As illustrated in FIG. 6A, the rods 40 may extend from the back surface 12 of the first member 10 toward the second member 20, and the second air gaps 41 may be formed between the rods 40 and the front surface 21 of the second member 20.

In the first embodiment and the modification thereof, the case where the first waveguide member 30 is provided on the front surface 21 of the second member 20 is described as an example, but the present disclosure is not limited to this case. FIG. 6B is a cross-sectional view illustrating another example of the first waveguide member. As illustrated in FIG. 6B, the first waveguide member 30 may be provided on the back surface 12 of the first member 10. In this case, one end of the first waveguide member 30 is adjacent to the first through hole 13, and the other end thereof overlaps with the second through hole 23 or the third through hole 24.

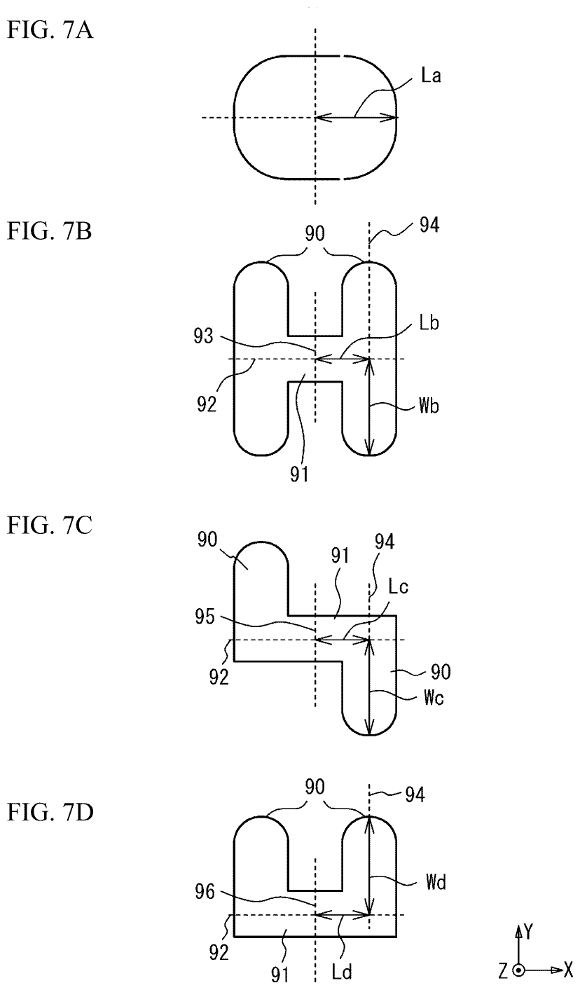

In the first embodiment and the modification thereof, the case where the first through hole 13, the second through hole 23, and the third through hole 24 are rectangular in plan view in the Z-axis direction is described as an example, but the present disclosure is not limited to this case. FIGS. 7A to 7D are plan views illustrating other examples of the first through hole, the second through hole, and the third through hole. As illustrated in FIG. 7A, each of the first to third through holes may have an oval shape in the plan view in the Z-axis direction. In this case, the semimajor axis La is set so that high-order resonance does not occur and the impedance does not become too small. For example, the semimajor axis La is set to λ₀/4<La<λ₀/2. Note that the shape may be an elliptical shape instead of the oval shape.

As illustrated in FIG. 7B, each of the first to third through holes may have an H-shape having a pair of vertical portions 90 and a lateral portion 91 connecting the pair of vertical portions 90 in the plan view in the Z-axis direction. The lateral portion 91 is substantially perpendicular to the pair of vertical portions 90 and connects substantially central portions of the pair of vertical portions 90. Even in such a case, the shape and the size of the first to third through holes are determined so that high-order resonance does not occur and the impedance does not become too small. A distance between an intersection of a center line 92 of the lateral portion 91 and a center line 93 of the entire H-shape perpendicular to the lateral portion 91 and an intersection of the center line 92 and a center line 94 of the vertical portion 90 is denoted by Lb. A distance between the intersection of the center line 92 and the center line 94 and an end of the vertical portion 90 is denoted by Wb. The sum of Lb and Wb is set so as to satisfy λ₀/4<Lb+Wb<λ₀/2. By making the distance Wb relatively long, the distance Lb can be made relatively short. Thereby, the width of the H-shape in the X-axis direction can be made less than λ₀/2, for example, and the length of the lateral portion 91 can be shortened.

As illustrated in FIG. 7C, each of the first to third through holes may have a shape including the lateral portion 91 and the pair of vertical portions 90 extending from both ends of the lateral portion 91 in the plan view in the Z-axis direction. The directions in which the pair of vertical portions 90 extend from the lateral portion 91 are substantially perpendicular to the lateral portion 91 and are opposite to each other. A distance between an intersection of the center line 92 of the lateral portion 91 and a center line 95 of the overall shape perpendicular to the lateral portion 91 and an intersection of the center line 92 and the center line 94 of the vertical portion 90 is denoted by Lc. A distance between an intersection of the center line 92 and the center line 94 and an end of the vertical portion 90 is denoted by Wc. The sum of Lc and Wc is set so as to satisfy λ₀/4<Lc+Wc<λ₀/2. By making the distance Wc relatively long, the distance Lc can be made relatively short. Thereby, the width of the entire shape in the X-axis direction can be made less than λ₀/2, for example, and the length of the lateral portion 91 can be shortened.

As illustrated in FIG. 7D, each of the first to third through holes may have a U-shape having the lateral portion 91 and the pair of vertical portions 90 extending from both ends of the lateral portion 91 in the same direction perpendicular to the lateral portion 91 in the plan view in the Z-axis direction. This shape can be considered as the shape of the upper half of the H-shape. A distance between an intersection of the center line 92 of the lateral portion 91 and a center line 96 of the entire U-shape perpendicular to the lateral portion 91 and an intersection of the center line 92 and the center line 94 of the vertical portions 90 is denoted by Ld. A distance between the intersection of the center line 92 and the center line 94 and an end of the vertical portion 90 is denoted by Wd. The sum of Ld and Wd is set so as to satisfy λ₀/4<Ld+Wd<λ₀/2. By making the distance Wd relatively long, the distance Ld can be made relatively short. Thereby, the width of the U-shape in the X-axis direction can be made less than λ₀/2, for example, and the length of the lateral portion 91 can be shortened.

### Second Embodiment

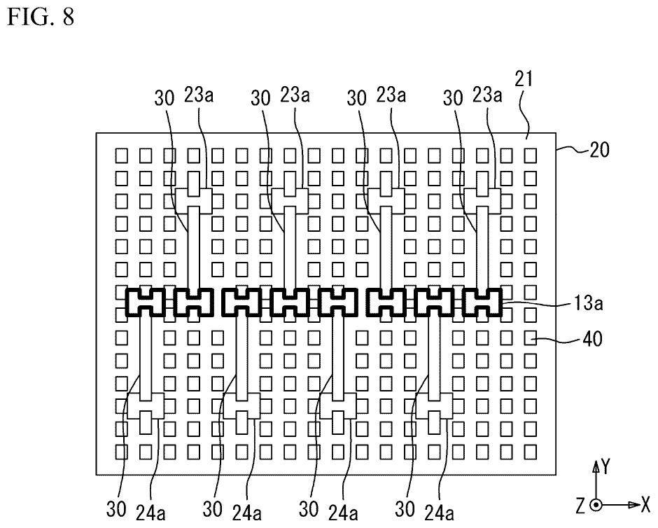

In a second embodiment, an example of a case where an H-shaped through hole is used will be described. FIG. 8 is a plan view illustrating the first through holes of the first member in a state of being overlapped with the second member in a second embodiment. As illustrated in FIG. 8, in the second embodiment, first through holes 13a, second through holes 23a, and third through holes 24a each having an H shape in plan view in the Z-axis direction are used. The plurality of first waveguide members 30 are provided so as to extend in straight lines between the first through holes 13a and the second through holes 23a or the third through holes 24a. The other configurations are the same as those of the first embodiment, and thus the description thereof will be omitted.

### Modification

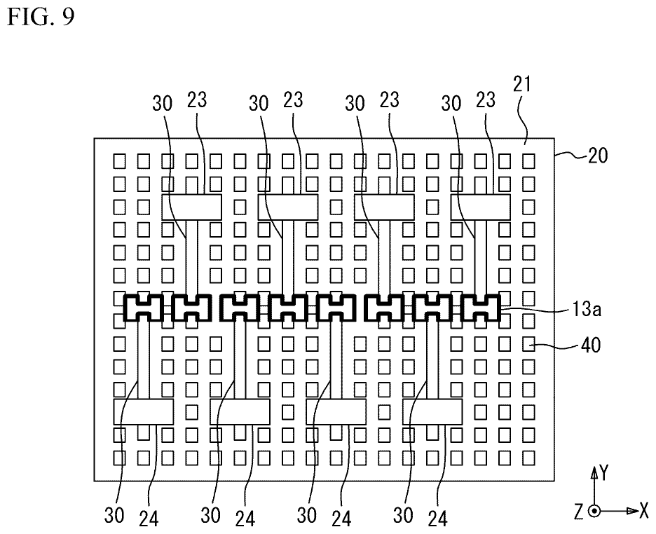

FIG. 9 is a plan view illustrating the first through holes of the first member in a state of being overlapped with the second member in a modification of the second embodiment. As illustrated in FIG. 9, in the modification of the second embodiment, the first through holes 13a each having an H-shape in plan view in the Z-axis direction, and the second through holes 23 and the third through holes 24 each having a rectangular shape in plan view are used. The plurality of first waveguide members 30 are provided so as to extend in straight lines between the first through holes 13a and the second through holes 23 or the third through holes 24. The other configurations are the same as those of the first embodiment, and thus the description thereof will be omitted.

### Comparative Example

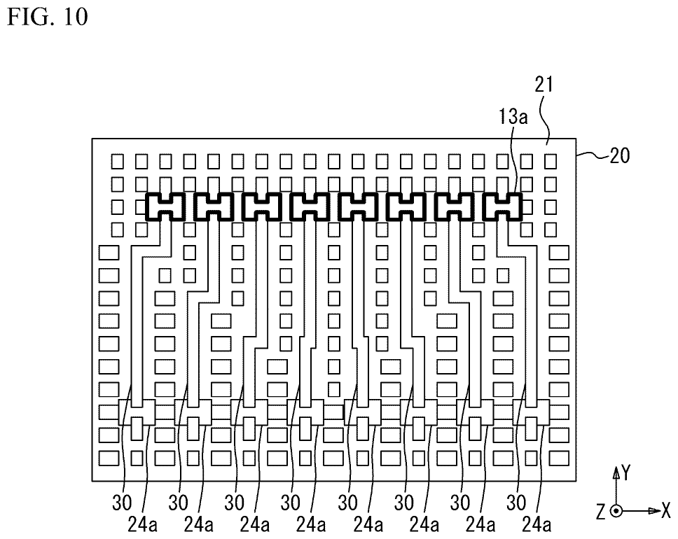

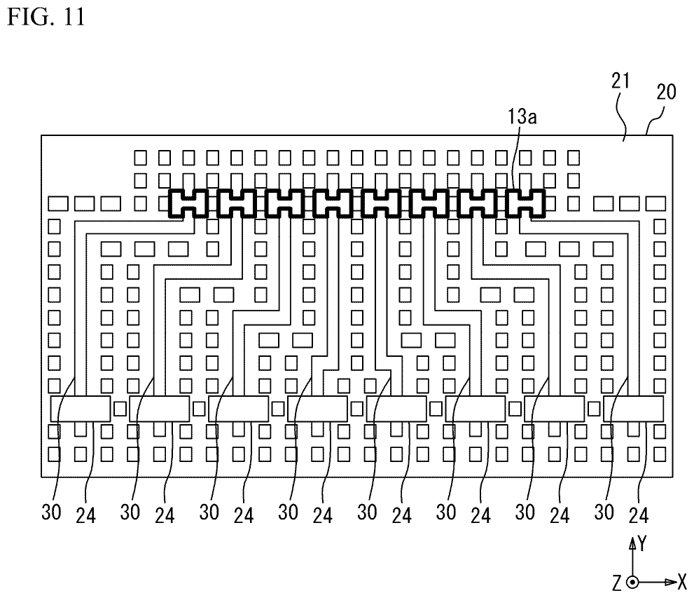

FIG. 10 is a plan view illustrating the first through holes of the first member in a state of being overlapped with the second member in a second comparative example. FIG. 11 is a plan view illustrating the first through holes of the first member in a state of being overlapped with the second member in a third comparative example. As illustrated in FIG. 10, in the second comparative example, a plurality of third through holes 13a are provided to be located on the −Y direction side with respect to the plurality of first through holes 24a, but the second through holes located on the +Y direction side with respect to the plurality of first through holes 13a are not provided. The other configurations are the same as those of the first embodiment, and thus the description thereof will be omitted.

As illustrated in FIG. 11, in the third comparative example, the plurality of third through holes 24 are provided to be located on the −Y direction side with respect to the plurality of first through holes 13a, but the second through holes located on the +Y direction side with respect to the plurality of first through holes 13a are not provided. The other configurations are the same as those of the first embodiment, and thus the description thereof will be omitted.

Even when the through holes each having an H-shape in plan view in the Z-axis direction are used, if only the third through holes 24 and 24a located on the −Y direction side with respect to the first through holes 13a are provided as in the second comparative example and the third comparative example, the plurality of first waveguide members 30 are disposed close to each other, and the isolation between the waveguides of adjacent first waveguide members 30 is reduced.

In contrast, as in the second embodiment and the modification thereof, a structure in which the second through holes 23 or 23a are provided on the +Y direction side with respect to the first through holes 13a and the third through holes 24 or 24a are provided on the −Y direction side with respect to the first through holes 13a is used, so that even when H-shaped through holes are used, it is possible to suppress a decrease in isolation between the waveguides of the first waveguide members 30, as in the first embodiment.

In addition, in the case of using the H-shaped through holes, as described with reference to FIG. 7B, the width of the through hole can be set to less than λ₀/2. That is, the widths of the first through hole 13a, the second through hole 23a, and the third through hole 24a in the X-axis direction can be less than λ₀/2. Even in this case, as described above, for the structural reason of the power feeding units provided to overlap with the second through hole 23a and the third through hole 24a, the interval between the adjacent second through holes 23a and the interval between the adjacent third through holes 24a are wider than the interval between the adjacent first through holes 13a. Therefore, in the second comparative example, as illustrated in FIG. 10, the size of the region in the X-axis direction where the plurality of third through holes 24a are provided is larger than the size of the region in the X-axis direction where the plurality of first through holes 13a are provided, and the array antenna is increased in size in the X-axis direction. In contrast, as illustrated in FIG. 8 of the second embodiment, a structure in which the second through holes 23a are provided on the +Y direction side with respect to the first through holes 13a, and the third through holes 24a are provided on the −Y direction side with respect to the first through holes 13a is used, so that even when the H-shaped through holes are used, the array antenna can be downsized in the X-axis direction as in the first embodiment.

### Third Embodiment

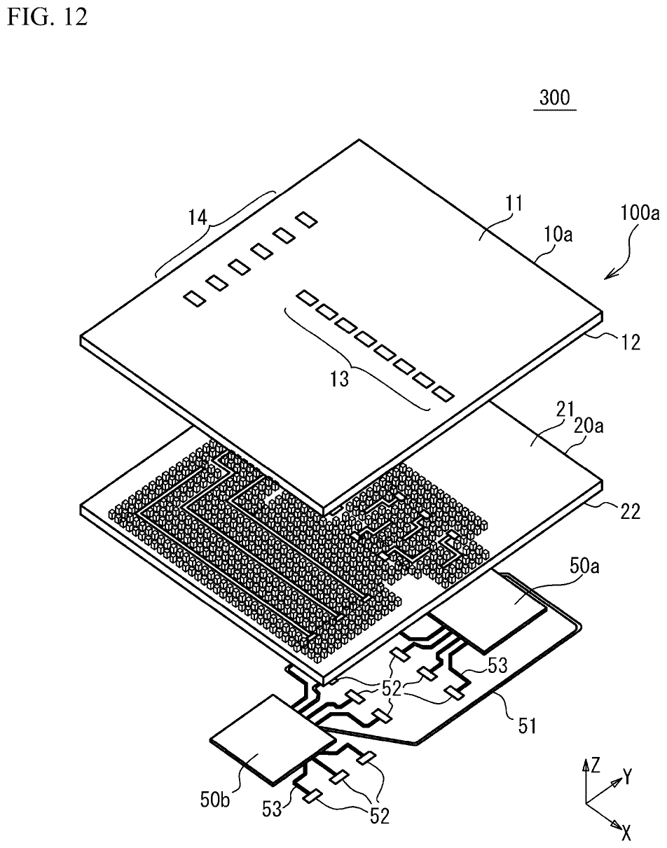

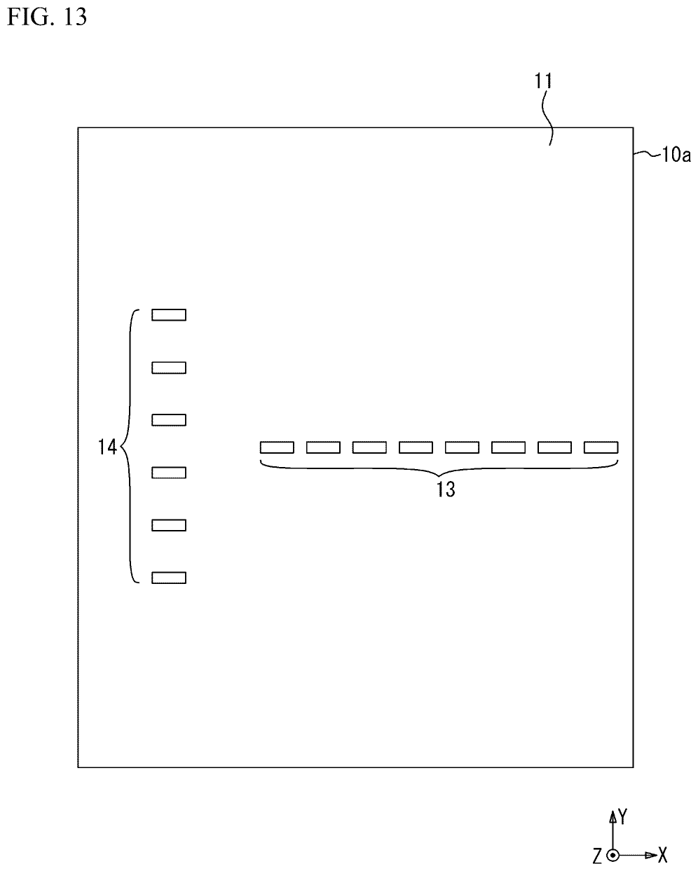

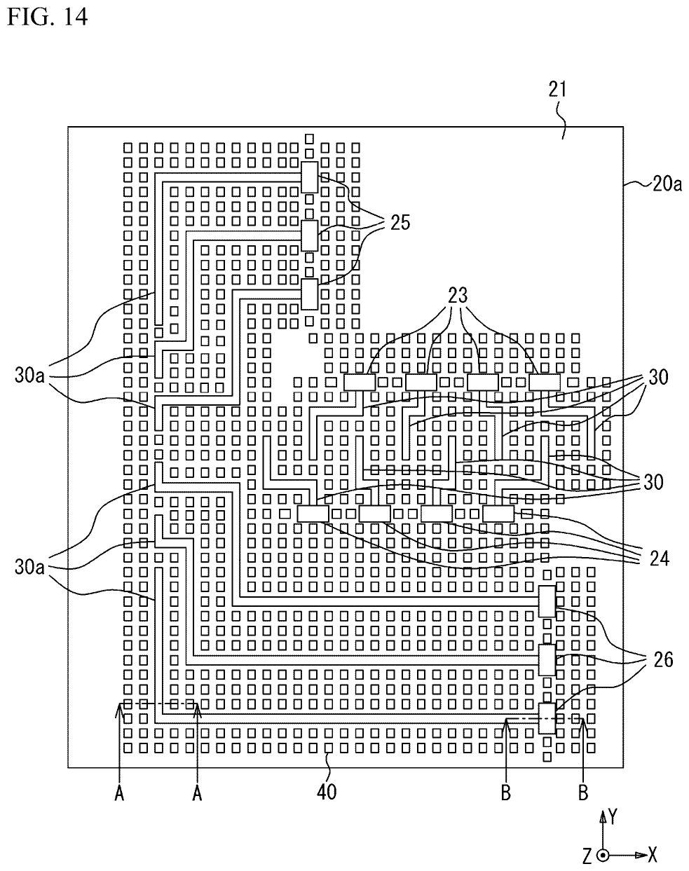

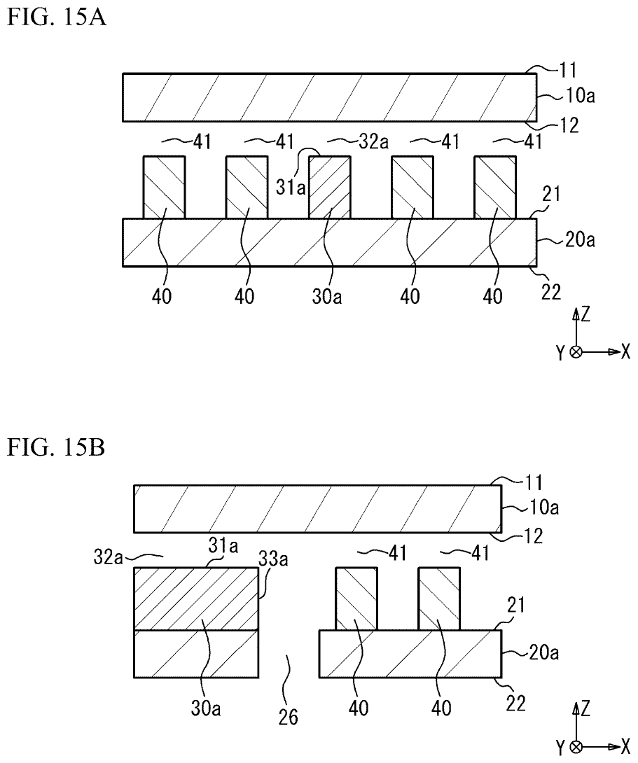

FIG. 12 is an exploded perspective view of an electromagnetic wave device according to a third embodiment. FIG. 13 is a plan view of a first member in the third embodiment. FIG. 14 is a plan view of a second member in the third embodiment. FIGS. 15A and 15B are cross-sectional views of an array antenna in the third embodiment. FIG. 15A is a cross-sectional view taken along a line A-A in FIG. 14, and FIG. 15B is a cross-sectional view taken along a line B-B in FIG. 14.

As illustrated in FIG. 12, an electromagnetic wave device 300 according to the third embodiment includes an array antenna 100a, and integrated circuits 50a and 50b, which are, for example, transmission/reception circuits cascade-connected by a wiring 51. The array antenna 100a includes a first member 10a and a second member 20a. The integrated circuits 50a and 50b are disposed on the back surface 22 of the second member 20a. The integrated circuits 50a and 50b are electrically connected to a plurality of power feeding units 52 by wirings 53. The integrated circuits 50a and 50b are, for example, monolithic microwave integrated circuits (MMICs).

As illustrated in FIG. 13, the first member 10a has a plurality of fourth through holes 14 located on the lateral side of the plurality of first through holes 13 in the X-axis direction and arranged at equal intervals in the Y-axis direction, in addition to the plurality of first through holes 13 arranged at equal intervals in the X-axis direction. Here, the plurality of fourth through holes 14 may be arranged along the Y-axis, similarly to the plurality of first through holes 13 illustrated in FIG. 23. That is, the plurality of fourth through holes 14 may be arranged in the Y-axis direction, may be arranged to be deviated from the Y-axis due to a processing error or the like during mass production, may be arranged in a direction intentionally inclined from the Y-axis by several degrees, or may be arranged in the Y-axis direction and in a zigzag manner in the X-axis direction. The fourth through hole 14 penetrates from the front surface 11 of the first member 10a to the back surface 12, for example. The plurality of fourth through holes 14 have the same shape and the same size as the plurality of first through holes 13.

As illustrated in FIG. 14, FIG. 15A, and FIG. 15B, a plurality of second waveguide members 30a are provided on the front surface 21 of the second waveguide member 30a, in addition to the plurality of first waveguide members 30. The second waveguide member 30a has the same structure as the first waveguide member 30. Thus, the second waveguide member 30a has a conductive second waveguide surface 31a facing the back surface 12 of the first member 10a, and a third air gap 32a is formed between the second waveguide surface 31a and the back surface 12 of the first member 10a. The electromagnetic waves propagate through the third air gap 32a.

In addition to the plurality of second through holes 23 and the plurality of third through holes 24, a plurality of fifth through holes 25 and a plurality of sixth through holes 26 are provided in the second member 20a. The fifth through hole 25 and the sixth through hole 26 penetrate from the front surface 21 of the second member 20a to the back surface 22, for example. A tip 33a of the second waveguide member 30a is adjacent to the fifth through hole 25 or the sixth through hole 26. Each of the fifth through hole 25 and the sixth through hole 26 has a conductive inner surface as well as the second through hole 23 and the third through hole 24. Therefore, the fifth through hole 25 and the sixth through hole 26 function as the waveguide tubes through which the electromagnetic waves propagate. The electromagnetic wave propagating through the third air gap 32a on the second waveguide member 30a are supplied from or extracted to the lower side of the second member 20a via the fifth through hole 25 or the sixth through hole 26.

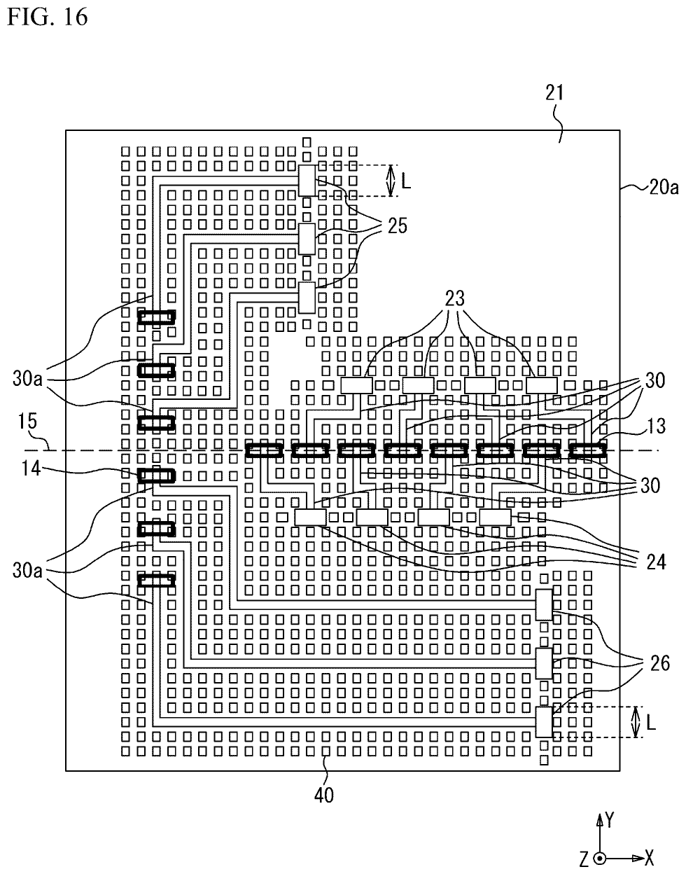

FIG. 16 is a plan view illustrating the first through holes and the fourth through holes of the first member in a state of being overlapped with the second member in the third embodiment. As illustrated in FIG. 16, the plurality of fifth through holes 25 are provided on the opposite side of the imaginary line 15 along which the plurality of first through holes 13 are arranged, with respect to the plurality of second through holes 23. The plurality of sixth through holes 26 are provided on the opposite side of the imaginary line 15 along which the plurality of first through holes 13 are arranged, with respect to the plurality of third through holes 24. The plurality of fifth through holes 25 are arranged along the Y-axis direction, and the plurality of sixth through holes 26 are also arranged along the Y-axis direction. Since the fifth through hole 25 and the sixth through hole 26 function as the waveguide tubes, the length L of the fifth through hole 25 and the sixth through hole 26 in the longitudinal direction (Y-axis direction) is equal to or longer than a half wavelength of the propagating electromagnetic wave.

One end of each of the plurality of first waveguide members 30 overlaps with the first through hole 13 and the other end of each of the plurality of first waveguide members 30 is adjacent to the second through hole 23 or the third through hole 24 in plan view in the Z-axis direction, and one end of each of the plurality of second waveguide members 30a overlaps with the fourth through hole 14 and the other end of each of the plurality of second waveguide members 30a is adjacent to the fifth through hole 25 or the sixth through hole 26. Therefore, the electromagnetic waves propagating through the third air gaps 32a on the plurality of second waveguide members 30a are emitted to the external space or incident from the external space via the fourth through holes 14. In this manner, the fourth through hole 14 functions as an antenna element (emitting element) that transmits or receives the electromagnetic wave to or from the external space as well as the first through hole 13. In the second embodiment, a case where the plurality of first through holes 13 function as receiving antenna elements and the plurality of fourth through holes 14 function as transmitting antenna elements will be described as an example. The first waveguide member 30 and the second waveguide member 30a extend from a direction (Y-axis direction) orthogonal to the longitudinal direction (X-axis direction) of the first through hole 13 and the fourth through hole 14 so as to overlap with the first through hole 13 and the fourth through hole 14, respectively.

The plurality of second waveguide members 30a are not limited to being provided on the front surface 21 of the second member 20, and may be provided on the back surface 12 of the first member 10, as in FIG. 6B. In this case, one end of each of the plurality of second waveguide members 30a is adjacent to the fourth through hole 14, and the other end of each of the plurality of second waveguide members 30a overlaps with the fifth through hole 25 or the sixth through hole 26. At least one of the first through hole 13, the second through hole 23, the third through hole 24, the fourth through hole 14, the fifth through hole 25, and the sixth through hole 26 is not limited to a rectangular shape, and may have another shape such as an H-shape illustrated in FIGS. 7A to 7D.

The plurality of rods 40 are provided not only around the first waveguide members 30, the second through holes 23, and the third through holes 24, but also around the second waveguide members 30a, the fifth through holes 25, and the sixth through holes 26. The rods 40 are provided around the second waveguide members 30a, so that the electromagnetic wave propagating through the third air gap 32a on the second waveguide member 30a is suppressed from leaking laterally. In addition, the rods 40 are provided in the vicinity of the corner portions of the fifth through hole 25 and the sixth through hole 26, so that the electromagnetic wave is suppressed from leaking to the lateral sides of the fifth through hole 25 and the sixth through hole 26.

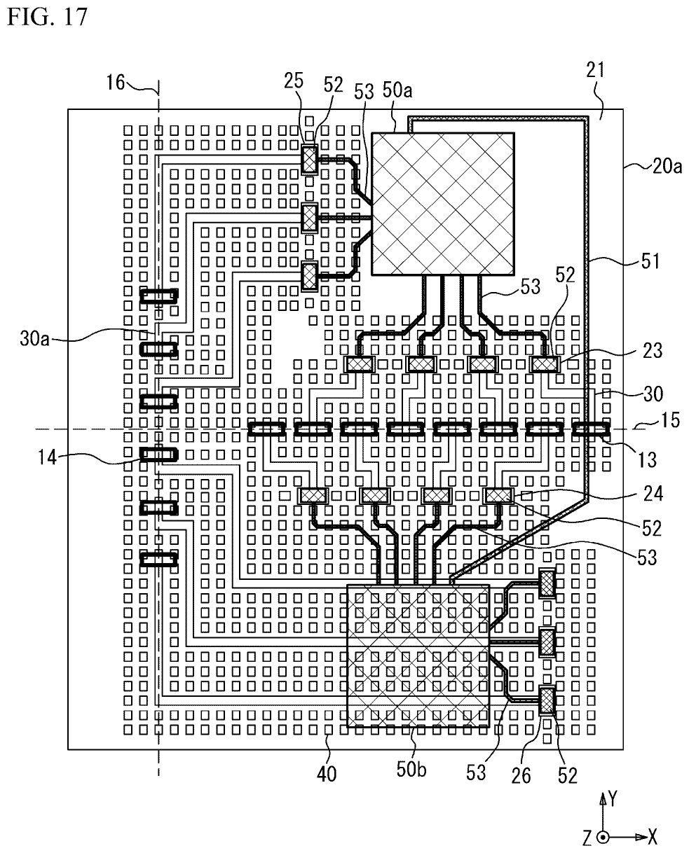

FIG. 17 is a plan view illustrating integrated circuits in a state of being overlapped with the second member in the third embodiment. In FIG. 17, for the sake of clarity of the drawing, the integrated circuits 50a and 50b, the wiring 51, the power feeding units 52, and the wirings 53 disposed on the back surface 22 of the second member 20 are hatched. As illustrated in FIG. 17, the integrated circuit 50a is disposed on the opposite side of the imaginary line 15 along which the plurality of first through holes 13 are arranged, with respect to the plurality of second through holes 23. The integrated circuit 50b is disposed on the opposite side of the imaginary line 15 along which the first through holes 13 are arranged, with respect to the plurality of third through holes 24.

The integrated circuit 50a is electrically connected to, via the wirings 53, the plurality of power feeding units 52 provided to overlap with the plurality of second through holes 23 and the plurality of power feeding units 52 provided to overlap with the plurality of fifth through holes 25 in plan view in the Z-axis direction. The integrated circuit 50b is electrically connected to, via the wirings 53, the plurality of power feeding units 52 provided to overlap with the plurality of third through holes 24 and the plurality of power feeding units 52 provided to overlap with the plurality of sixth through holes 26 in plan view in the Z-axis direction.

The electromagnetic waves generated in the integrated circuits 50a and 50b are supplied to the third air gaps 32a on the second waveguide members 30a via the plurality of fifth through holes 25 and the plurality of sixth through holes 26, and are emitted to the external space from the plurality of fourth through holes 14 after propagating through the third air gap 32a. The electromagnetic waves that have propagated through the external space are taken into the first air gaps 32 on the first waveguide members 30 through the plurality of first through holes 13, propagate through the first air gaps 32, and then are sent to the integrated circuits 50a and 50b via the plurality of second through holes 23 and the plurality of third through holes 24.

As illustrated in FIG. 16, the longitudinal direction of the first through hole 13 functioning as the receiving antenna terminal and the longitudinal direction of the fourth through hole 14 functioning as the transmitting antenna terminal are both the X-axis direction. In this manner, by setting the longitudinal directions of the first through hole 13 and the fourth through hole 14 to the same direction, the polarization directions of the electromagnetic waves in the receiving antenna element and the transmitting antenna element can be aligned. As illustrated in FIG. 17, the imaginary line 15 along which the plurality of first through holes 13 are arranged is in the X-axis direction, whereas an imaginary line 16 along which the plurality of fourth through holes 14 are arranged is in the Y-axis direction. This is to make the array antenna have a MIMO configuration described later.

The array antenna 100a in the third embodiment is a multi-input multi-output (MIMO) array antenna in which the plurality of first through holes 13 functioning as receiving antenna elements are arranged along the X-axis direction and a plurality of fourth through holes 14 functioning as transmitting antenna elements are arranged along the Y-axis direction. In this case, the process of emitting the electromagnetic waves from one of the plurality of fourth through holes 14 and receiving the electromagnetic waves by the plurality of first through holes 13, and then emitting the electromagnetic waves from another one of the plurality of fourth through holes 14 and receiving the electromagnetic waves by the plurality of first through holes 13 is repeated for all of the plurality of fourth through holes 14. This provides a function equivalent to that of multiple-input single-output (MISO). The electromagnetic wave device 300 operates in a method such as a frequency modulated continuous wave (FM-CW) method or a fast-chirp modulation (FCM) method. The electromagnetic wave device 300 is a three dimensional radar device capable of measuring, for example, a distance, an azimuth, and an elevation angle. The electromagnetic wave device 300 emits millimeter waves of, for example, 30 GHz or more and 300 GHz or less.

According to the third embodiment, the array antenna 100a includes the first member 10a and the second member 20a. The first member 10a has the plurality of first through holes 13 arranged along the X-axis direction and the plurality of fourth through holes 14 arranged along the Y-axis direction. The second member 20a has the plurality of second through holes 23, the plurality of third through holes 24, the plurality of fifth through holes 25, and the plurality of sixth through holes 26. The plurality of second through holes 23 and the plurality of third through holes 24 are disposed on the opposite sides with respect to the plurality of first through holes 13. The plurality of fifth through holes 25 are disposed on the opposite side of the plurality of first through holes 13 with respect to the plurality of second through holes 23, and the plurality of sixth through holes 26 are disposed on the opposite side of the plurality of first through holes 13 with respect to the plurality of third through holes 24. By arranging the second through hole 23 and the third through hole 24, through which the electromagnetic waves are propagated between the first through hole 13, and the second through hole 23 and the third through hole 24 via the first waveguide members 30, and the fifth through hole 25 and the sixth through hole 26, through which the electromagnetic waves are propagated between the fourth through hole 14, and the fifth through hole 25 and the sixth through hole 26 via the second waveguide members 30a, in this manner, the array antenna 100a can be reduced in size in the X-axis direction and the Y-axis direction. In addition, the number of layers for forming the array antenna 100a can be reduced.

In the third embodiment, the integrated circuit 50a is disposed on the opposite side of the plurality of first through holes 13 with respect to the plurality of second through holes 23, and is connected to the plurality of power feeding units 52 overlapping the plurality of second through holes 23. The integrated circuit 50b is disposed on the opposite side of the plurality of first through holes 13 with respect to the plurality of third through holes 24, and are connected to the plurality of power feeding units 52 overlapping the plurality of third through holes 24. This makes it possible to shorten the wirings 53 connecting the integrated circuits 50a and 50b and the power feeding unit 52. Therefore, it is possible to suppress the complexity of the wirings 53.

In the third embodiment, the longitudinal direction of the plurality of first through holes 13 and the longitudinal direction of the plurality of fourth through holes 14 are both the X-axis direction. In this manner, by setting the longitudinal directions of the first through holes 13 and the fourth through holes 14 to the same direction, the polarized waves of the electromagnetic waves can be aligned in the first through holes 13 and the fourth through holes 14.

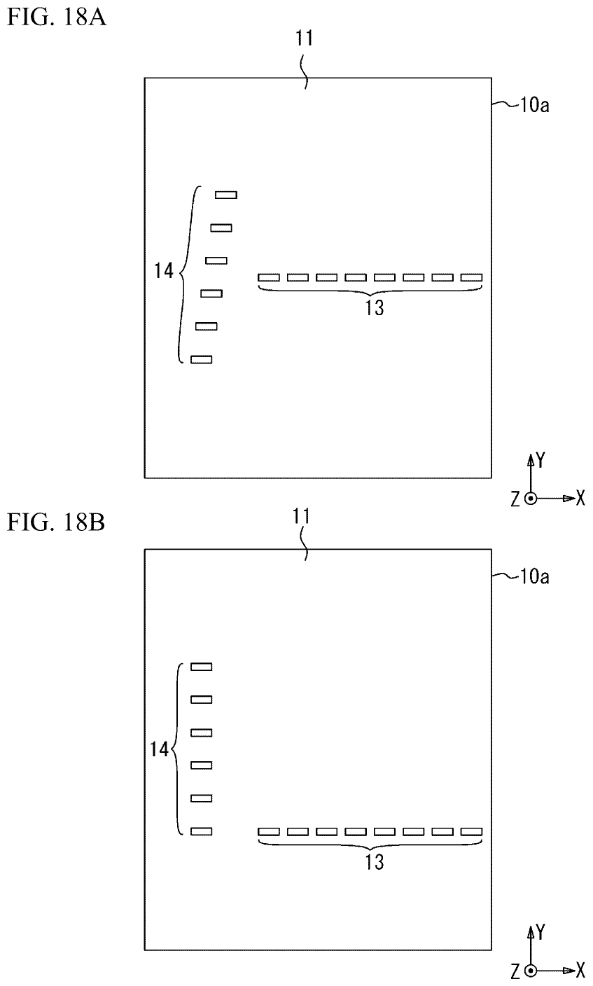

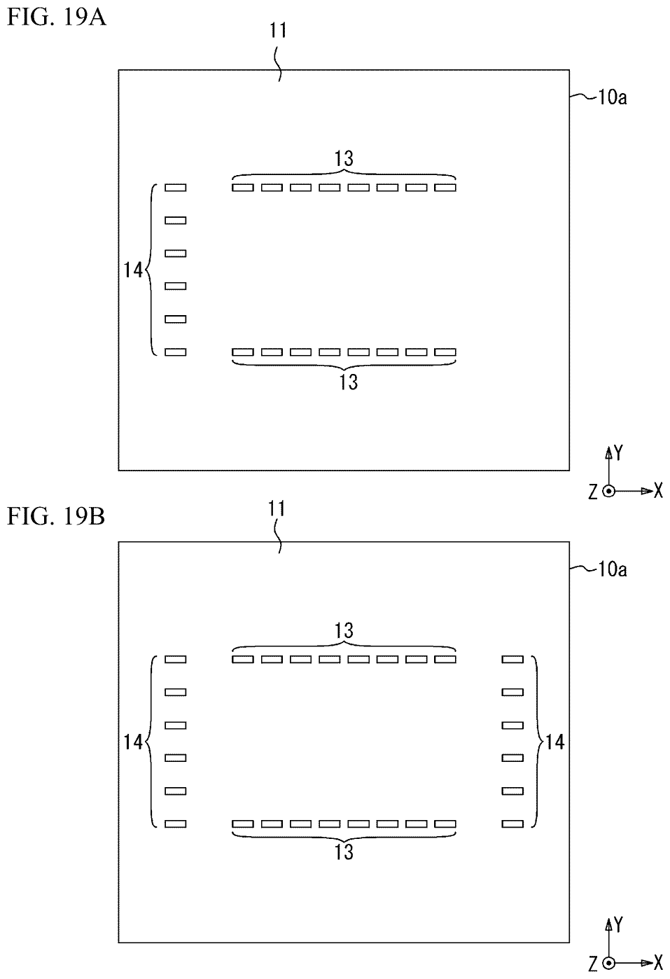

In the third embodiment, as illustrated in FIG. 13, the case where the plurality of first through holes 13 arranged along the X-axis direction are provided on the lateral side of the central portion of the plurality of fourth through holes 14 arranged in the Y-axis direction is illustrated as an example, but the present disclosure is not limited to this case. FIG. 18A to FIG. 19B are plan views illustrating other arrangement examples of the first through holes and the fourth through holes. As illustrated in FIG. 18A, the plurality of fourth through holes 14 may be arranged along the Y-axis direction so as to be inclined by 45 degrees or more and less than 90 degrees with respect to the X-axis direction in which the plurality of first through holes 13 are arranged. The plurality of fourth through holes 14 may be inclined at about 60 degrees or about 80 degrees with respect to the X-axis direction, for example. By adjusting an angle between the arrangement direction of the plurality of first through holes 13 and the arrangement direction of the plurality of fourth through holes 14, the virtual shape of the array antenna by the MIMO processing of the array antenna can be changed. This makes it possible to configure an array antenna suitable for various applications.

As illustrated in FIG. 18B, the plurality of first through holes 13 arranged along the X-axis direction may be provided on the lateral side of one end of the plurality of fourth through holes 14 arranged along the Y-axis direction. As illustrated in FIG. 19A, the plurality of first through holes 13 arranged along the X-axis direction may be provided on the lateral sides of both ends of the plurality of fourth through holes 14 arranged along the Y-axis direction. As illustrated in FIG. 19B, the plurality of first through holes 13 arranged along the X-axis direction may be provided between both ends of the plurality of fourth through holes 14 arranged along the Y-axis direction and separated from each other in the X-axis direction.

### Fourth Embodiment

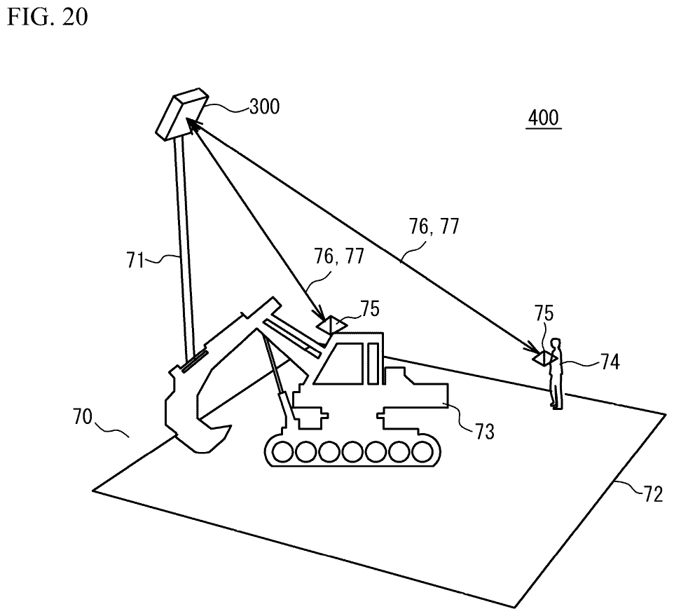

FIG. 20 is a schematic diagram of a monitoring system according to a fourth embodiment. As illustrated in FIG. 20, in a monitoring system 400 according to the fourth embodiment, the electromagnetic wave device 300 according to the third embodiment is installed above a ground 70 via a support 71. The electromagnetic wave device 300 is, for example, a radar device that emits millimeter waves. The millimeter wave is emitted from the electromagnetic wave device 300 toward a monitoring area 72 in an obliquely downward direction. The monitoring area 72 is set in advance in, for example, a storage unit of the electromagnetic wave device 300.

Reflectors 75 are attached to a heavy machine 73 and a worker 74. For example, the reflector 75 is attached in the vicinity of the cockpit of the heavy machine 73. For example, the reflector 75 is attached to a vest worn by the worker 74. The reflector 75 is formed of a material having a high reflection intensity with respect to the millimeter wave emitted from the electromagnetic wave device 300, and is formed of, for example, a metal body such as copper having a surface with less unevenness subjected to polishing or the like, or a thin film body thereof. The reflector 75 to be attached to the heavy machine 73 may be attached to a place other than the vicinity of the cockpit, and may be attached to an attachment in the case of a shovel car, for example. The reflector 75 to be attached to the worker 74 may be attached to a place other than the vest, and may be attached to, for example, a helmet, a glove, a belt, trousers, shoes, a mask, or glasses.

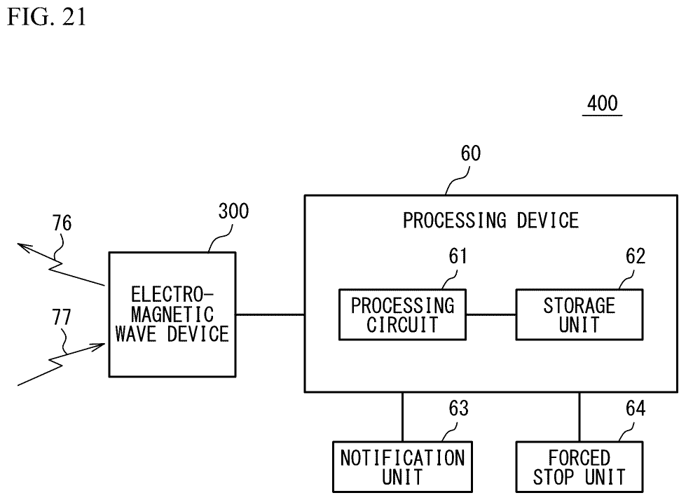

FIG. 21 is a block diagram of a monitoring system according to a fourth embodiment. As illustrated in FIG. 21, the monitoring system 400 includes the electromagnetic wave device 300 according to the third embodiment, a processing device 60 electrically connected to the electromagnetic wave device 300, and a notification unit 63 and a forced stop unit 64 electrically connected to the processing device 60. The processing device 60 includes a processing circuit 61 and a storage unit 62. The electromagnetic wave device 300 and the processing device 60 may be connected by wire or wirelessly. Similarly, the processing device 60, and the notification unit 63 and the forced stop unit 64 may be connected by wire or wirelessly.

As illustrated in FIGS. 20 and 21, the electromagnetic wave device 300 irradiates the monitoring area 72 with millimeter waves 76. When the heavy machine 73 including the reflector 75, and the worker 74 are present in the monitoring area 72, the millimeter waves 76 are irradiated to the reflector 75 of the heavy machine 73 and the worker 74. The electromagnetic wave device 300 receives millimeter waves 77 reflected by the reflectors 75. The processing circuit 61 of the processing device 60 acquires reception signals of the millimeter waves 77 from the electromagnetic wave device 300, and detects predetermined information based on the acquired reception signals. For example, the processing circuit 61 detects information about the positions of the heavy machine 73 and the worker 74. The electromagnetic wave device 300 irradiates the monitoring area 72 with the millimeter waves 76 in the obliquely downward direction, and receives the millimeter waves 77 reflected by the reflector 75 and traveling in the obliquely upward direction, and thus the processing circuit 61 calculates, for example, the positions of the heavy machine 73 and the worker 74 in the plane coordinates, and detects a distance between the heavy machine 73 and the worker 74.

In order to distinguish between the millimeter wave 77 reflected by the reflector 75 of the heavy machine 73 and the millimeter wave 77 reflected by the reflector 75 of the worker 74, the reflection intensities may be made different by making the materials and/or the sizes of the respective reflectors 75 different. As an example, the reflection intensity of the reflector 75 of the heavy machine 73 may be made larger than that of the reflector 75 of the worker 74. In addition, a plurality of reflectors 75 may be attached to the worker 74, and a plurality of reflectors 75 may be attached to the heavy machine 73 at intervals wider than those of the reflectors 75 attached to the worker 74, so that the millimeter waves 77 reflected by the reflectors 75 of the heavy machine 73 and the millimeter waves 77 reflected by the reflectors 75 of the worker 74 can be distinguished from each other.

When the distance between the heavy machine 73 and the worker 74 becomes equal to or less than a predetermined distance stored in advance in the storage unit 62, the processing circuit 61 gives an instruction to the notification unit 63 to notify a visual and/or auditory alarm, or gives an instruction to the forced stop unit 64 to forcibly stop the heavy machine 73 by remote control.

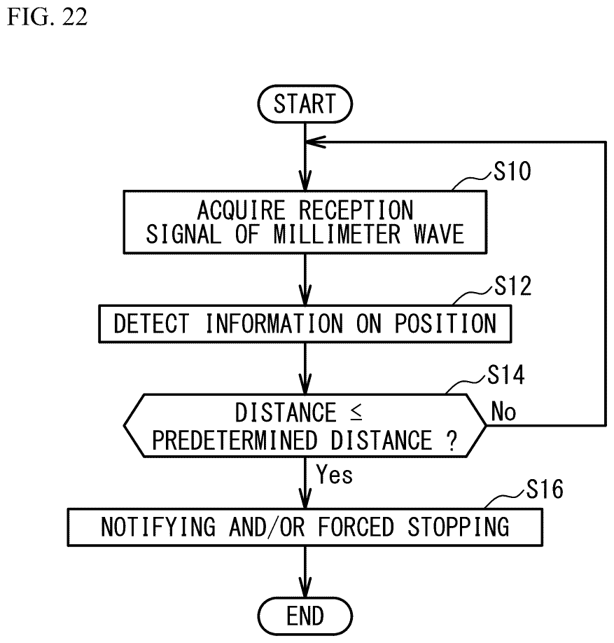

FIG. 22 is a flowchart illustrating an example of processing performed by a processing circuit according to the fourth embodiment. As illustrated in FIG. 22, the processing circuit 61 acquires reception signals of the millimeter waves 77 reflected by the reflectors 75 of the heavy machine 73 and the worker 74 from the electromagnetic wave device 300 (step S10). Next, the processing circuit 61 detects information on the positions of the heavy machine 73 and the worker 74 based on the reception signals acquired in step S10 (step S12). Next, the processing circuit 61 determines whether the distance between the heavy machine 73 and the worker 74 is equal to or less than the predetermined distance stored in the storage unit 62 based on the information detected in step S12 (step S14). If the distance is not equal to or less than the predetermined distance (step S14: No), the process returns to step S10. On the other hand, if the distance is equal to or less than the predetermined distance (step S14: Yes), the processing circuit 61 instructs the notification unit 63 and/or the forced stop unit 64 to perform notification for notifying danger and/or forced stopping of the heavy machine 73 (step S16).

As described above, according to the fourth embodiment, the processing device 60 acquires, from the electromagnetic wave device 300, the reception signals of the millimeter waves 77 reflected by the reflectors 75 provided on the heavy machine 73 and the worker 74 in the monitoring area 72. Then, the processing device 60 detects the information on the positions of the heavy machine 73 and the worker 74 based on the acquired reception signals of the millimeter waves 77. Since the monitoring system using the electromagnetic wave device 300 is less likely to be affected by weather or the like, even when smoke, fog, or the like is generated in the monitoring area 72, for example, the information on the positions of the heavy machine 73 and the worker 74 can be detected. Therefore, it is possible to suppress the occurrence of an accident such as the worker 74 being caught in the heavy machine 73.

Although the embodiments of the present disclosure are described in detail above, the present disclosure is not limited to the specific embodiments. It is to be understood that the various change, substitutions, and alterations could be made hereto without departing from the spirit and scope of the invention.

What is claimed is:

1. An array antenna comprising:
a first member having a plurality of first through holes arranged along a first direction, the first member having conductive surfaces, a direction orthogonal to the first direction being defined as a second direction, and a direction orthogonal to both the first direction and the second direction being defined as a third direction;
a second member that is provided to overlap with the first member in plan view in the third direction, and has a plurality of second through holes provided on one side with respect to the plurality of first through holes in the second direction and a plurality of third through holes provided on another side with respect to the plurality of first through holes in the second direction, the second member having conductive surfaces;
a plurality of first waveguide members each having a ridge shape and conductive surfaces, each of the first waveguide members being in contact with one of a first surface of the first member facing the second member and a second surface of the second member facing the first member, a first air gap functioning as a waveguide being formed between each of the first waveguide members and another of the first surface and the second surface, one end of each of the first waveguide members receiving a power from each of the plurality of second through holes or each of the plurality of third through holes, and another end of each of the first waveguide members feeding the power to each of the plurality of first through holes, or one end of each of the first waveguide members receiving a power from each of the plurality of first through holes, and another end of each of the first waveguide members feeding the power to each of the plurality of second through holes or each of the plurality of third through holes; and
a plurality of rods having conductive surfaces, the rods being provided around the plurality of first waveguide members, the rods being in contact with one of the first surface and the second surface and extending toward another of the first surface and the second surface, a second air gap being formed between the rods and the another of the first surface and the second surface.

2. The array antenna according to claim 1,
wherein the plurality of first waveguide members extend from the plurality of first through holes alternately in the second direction and a direction opposite to second direction with respect to the plurality of first through holes.

3. The array antenna according to claim 1,
wherein the plurality of second through holes and the plurality of third through holes are arranged along the first direction, and
wherein an interval between the plurality of second through holes in the first direction and an interval between the plurality of third through holes in the first direction are wider than an interval between the plurality of first through holes in the first direction.

4. The array antenna according to claim 3,
wherein each of the plurality of second through holes and the plurality of third through holes has a rectangular shape in plan view.

5. The array antenna according to claim 1,
wherein a length of each of the plurality of first through holes, the plurality of second through holes, and/or the plurality of third through holes in the first direction is shorter than λ₀/2, where λ₀ is a free space wavelength at a center frequency of a use band.

6. The array antenna according to claim 1,
wherein at least one of the plurality of first waveguide members extends in a straight line between the plurality of first through holes and the plurality of second through holes or the plurality of third through holes.

7. The array antenna according to claim 1,
wherein at least one of the plurality of first waveguide members extends while bending between the plurality of first through holes and the plurality of second through holes or the plurality of third through holes.

8. The array antenna according to claim 1,
wherein the plurality of first through holes are antenna elements that transmit electromagnetic waves to an external space or receive electromagnetic waves from the external space.

9. The array antenna according to claim 7,
wherein the plurality of first waveguide members are provided on the second surface of the second member, and the first air gap is formed between each of the first waveguide members and the first surface of the first member, and
wherein the plurality of rods are in contact with the second surface of the second member and extend toward the first surface of the first member, and the second air gap is formed between the first surface and each of the plurality of rods.

10. The array antenna according to claim 1, further comprising:
a plurality of second waveguide members each having a ridge shape and conductive surfaces, each of the second waveguide members being in contact with one of the first surface and the second surface, a third air gap functioning as a waveguide being formed between each of the second waveguide members and another of the first surface and the second surface;
wherein the plurality of rods are provided around each of the plurality of second waveguide members,
wherein the first member has a plurality of fourth through holes arranged along a fourth direction intersecting the first direction,
wherein the second member has a plurality of fifth through holes and a plurality of sixth through holes, and
wherein one end of each of the plurality of second waveguide members receives a power from each of the plurality of fifth through holes or each of the plurality of sixth through holes, and another end of each of the plurality of second waveguide members feeds the power to each of the plurality of fourth through holes, or one end of each of the plurality of second waveguide members receives a power from each of the plurality of fourth through holes, and another end of each of the plurality of second waveguide members feeds the power to each of the plurality of fifth through holes or each of the plurality of sixth through holes.

11. The array antenna according to claim 10,
wherein the plurality of fifth through holes are provided opposite to the plurality of first through holes with respect to the plurality of second through holes, and the plurality of sixth through holes are provided opposite to the plurality of first through holes with respect to the plurality of third through holes.

12. An electromagnetic wave device comprising:
the array antenna according to claim 1; and
an integrated circuit connected to the array antenna.
